(19) United States
(12) Patent Application Publication
(10) Pub. No.: US 2008/0202367 A1
(43) Pub. Date: Aug. 28, 2008

(54) Article for Stamping

(76) Inventor: Rosanna Biolcati Papa, Perugia (IT)

Correspondence Address: LACKENBACH SIEGEL, LLP, LACKENBACH SIEGEL BUILDING, 1 CHASE ROAD, SCARSDALE, NY, 10583, US

(21) Appl. No.: 11/913,910

(22) PCT Filed: May 10, 2006
(86) PCT No.: PCT/IB06/01220

§ 371 Date: Dec. 13, 2007

(30) Foreign Application Priority Data
May 11, 2005 (IT) BO2005A000337

(51) Int. Cl. B41K 1/42

(52) U.S. Cl. 101/333

(57) ABSTRACT

An article for stamping comprises a first and a second laminar element (2, 3) hinged together in such a way that they can pass from a closed configuration in which they are positioned on top of one another to an open configuration and vice versa; a raised graphic element (4) is connected to the first laminar element (2), the graphic element (4) being folded over the second laminar element (3) in the closed configuration.

### TECHNICAL FIELD

The present invention relates to an article for stamping.

Pocket articles for stamping are known, commonly called pocket stamps, in which the stamp and the pad are housed in a single container.

### BACKGROUND ART

The stamp is removed from the container for use, then put back in the container after use.

Articles for stamping are also known which have a handle to which a ready-inked stamp is attached whose stamping surface is covered by a lid when the article is not in use.

In some solutions the lid is hinged to the support, so that it closes onto the stamping surface like a book. Such articles normally have closing mechanisms which hold the lid stably in the closed configuration and, if necessary, also in the open configuration.

Articles for stamping are also known comprising a container in which there is an ink pad and a lid hinged to the container and supporting a stamp which has a raised graphic element.

The lid is mobile between a closed configuration in which the stamp is resting on the pad and an open configuration in which the stamp con be pressed on a generic support, for example a sheet of paper, to stamp it.

Said known pocket articles have several disadvantages.

Both of the known types have a significant overall thickness, in particular due to the containers and/or supports to be handled.

The articles for stamping which close like a book also have a significant thickness because the stamp, usually made of rubber, has the raised graphic element supported by a base which usually extends beyond the graphic element, forming an outer peripheral zone.

To prevent said peripheral zone from making contact with the pad when the stamp is closed, the height of the graphic element is such that it also acts as a separator element between the pad and the peripheral zone.

In this way the peripheral zone remains ink-free so that it does not dirty the support to be inked when the article for stamping is used.

Known stamps also have relatively small stamping surfaces.

The closing mechanisms also increase the overall thickness of the stamps and, due to their complexity, lead to high production costs.

### DISCLOSURE OF THE INVENTION

In this context, the main technical purpose of the present invention is to propose an article for stamping which is free of the above-mentioned disadvantages.

In particular, the aim of the present invention is to propose a pocket article for stamping which is thinner than the known articles and, therefore, easily portable.

Another aim of the present invention is to produce a pocket stamp that has a simple structure and so is easy to produce and economical.

The technical purpose indicated and the aims specified are substantially achieved by an article for stamping described in claim 1 and in one or more of the dependent claims herein.

### BRIEF DESCRIPTION OF THE DRAWINGS

Further characteristics and advantages of the present invention are more apparent in the detailed description below, with reference to a preferred, non-limiting, embodiment of an article for stamping, illustrated in the accompanying drawings, in which:

FIG. 1 is a schematic perspective view of an article for stamping in accordance with the present invention, in a partly open configuration;

FIG. 2 is a schematic cross-section of an enlarged detail of the article from FIG. 1, in a closed configuration;

FIG. 3 is a schematic perspective view of a second embodiment of an article for stamping in accordance with the present invention, in a partly open configuration;

FIG. 4 is a schematic side view of the article from FIG. 3 in an open configuration for use;

FIG. 5 is a cross-section, according to line III-III from FIG. 3, of the article in accordance with the present invention, in a closed configuration in which it is not used;

FIG. 6 is a schematic side view of a third embodiment of an article for stamping in accordance with the present invention;

FIG. 7 is a schematic top plan view of a fourth embodiment of an article in accordance with the present invention;

FIG. 8 is a schematic cross-section of the article from FIG. 7;

FIG. 9 is a schematic top plan view of a fifth embodiment of an article in accordance with the present invention;

FIG. 10 is a schematic cross-section of the article from FIG. 9;

FIG. 11 is a schematic cross-section of a sixth embodiment of an article in accordance with the present invention;

FIG. 12 is a schematic top plan view of a seventh embodiment of an article for stamping in accordance with the present invention, in an open configuration;

FIG. 13 is a schematic top plan view of the article for stamping from FIG. 12 in a closed configuration;

FIG. 14 shows the article from FIG. 9 in an open configuration for use.

### DETAILED DESCRIPTION OF THE PREFERRED OF THE EMBODIMENTS OF THE INVENTION

With reference to the accompanying drawings, the numeral 1 denotes an article for stamping in accordance with the present invention, in a partly open configuration.

The article 1 comprises a first and a second laminar element 2, 3 hinged together.

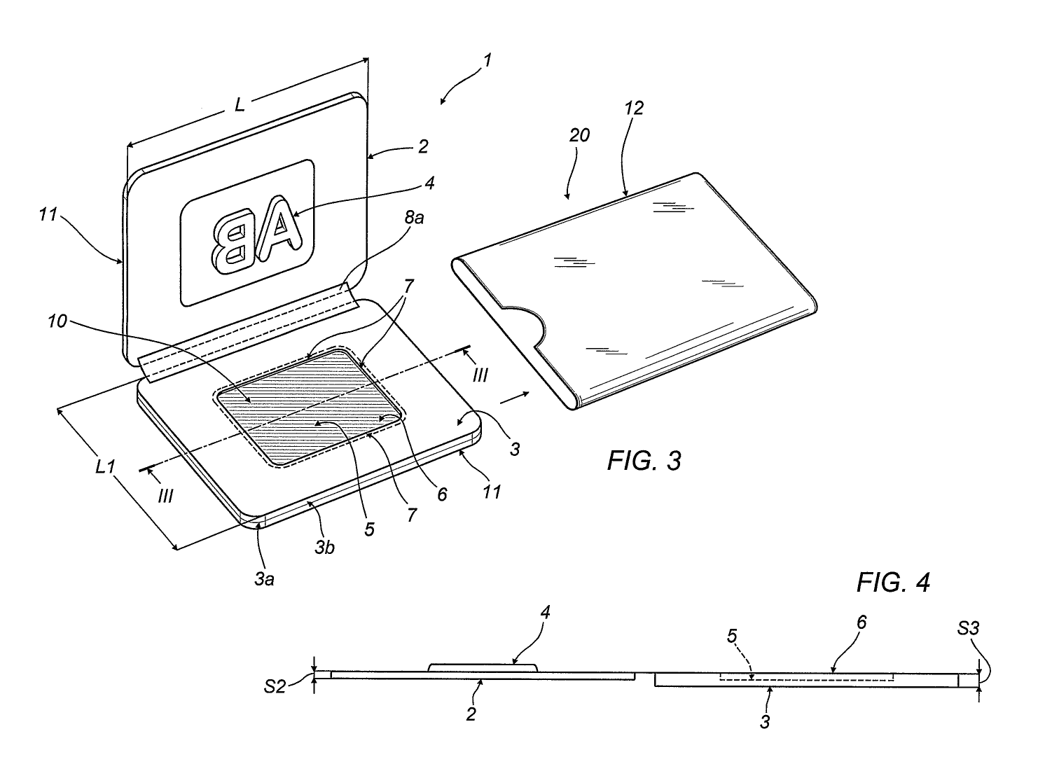

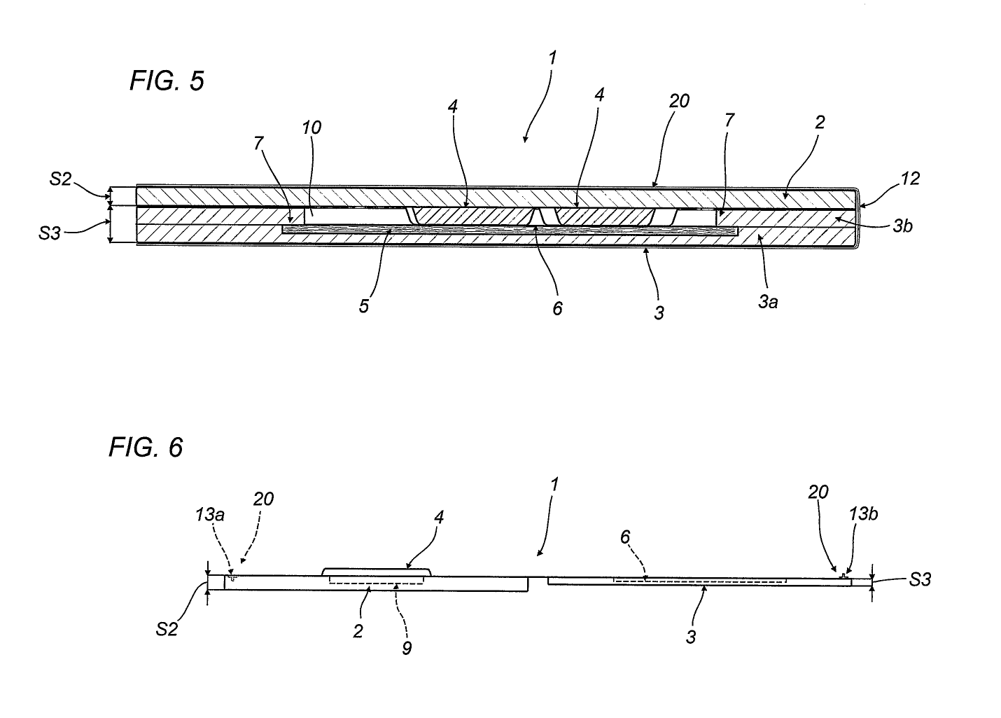

The elements 2 and 3 can move relative to one another between a closed configuration in which they are positioned on top of one another, illustrated in FIG. 5, relative to the solution from FIG. 3, and an open configuration, illustrated in FIGS. 4, 6, 7 and 9.

As illustrated in particular in FIG. 1, the elements 2 and 3 are made in a single body, for example by moulding, and are separated by a portion of material 8 with reduced thickness forming a hinge for rotation of the elements 2 and 3 relative to one another.

As illustrated in FIG. 3, the elements 2 and 3 are hinged together by an adhesive strip 8a, which may be doubled on the other side of the elements 2 and 3 by a similar strip, not illustrated.

A raised graphic element 4, with a height H1, is connected to the laminar element 2, for example by gluing, and is positioned in such a way that it folds over the second laminar element 3 in the closed configuration.

The element 4 comprises alphanumeric symbols such as names, codes, addresses and the like and even drawings which may be separate from one another or without gaps.

As is known, the element 4 is made as the negative of the desired shape to be obtained on any support, for example a sheet 100 illustrated in FIG. 14.

The element 4 is preferably made of a material suitable for stamping, such as rubber.

As illustrated in FIGS. 1, 3, 4 and 5, the article 1 comprises a pad 5 which can be loaded with ink, that is to say, a pad soaked with any stamping liquid, such as ink, referred to in the following description without in any way limiting the scope of the invention, attached to the laminar element 3.

Advantageously, in the substantially known way, as the ink is gradually used up, the pad 5 can be supplied with ink.

The graphic element 4 is in contact with the pad 5 in the closed configuration.

In this way, in the open configuration illustrated in FIG. 4, the element 4 can be used to mark the support, since the element 4 is covered by a film of ink from the pad 5.

The pad 5 is inserted and fixed in a seat 6 made in the laminar element 3.

As illustrated in FIG. 5, the seat 6 is also designed to receive the graphic element 4 in the article 1 closed configuration.

As illustrated in particular in FIG. 3, the second laminar element 3 has an edge 7 for holding the pad 5.

In particular, the edge 7 extends over the pad 5 guaranteeing that it is securely connected to the element 3.

Said edge 7 also allows any ink which escapes from the pad 5 to be contained, preventing it from leaking to the outside of the article 1.

It should be noticed that the laminar element 3 is preferably made by joining an outer portion 3a and an inner portion 3b.

The pad 5 is positioned on the outer portion 3a and held on it by the inner portion 3b.

The portion 3b in particular has an opening 10 at the pad 5.

In the preferred embodiment illustrated, the opening 10 is smaller than the pad 5, so that the edge 7 is formed.

As illustrated in FIG. 6, in a different embodiment the element 4 is of the ready-inked type.

In such a case, the article 1 comprises a reservoir 9 located in the first laminar element 2, to supply ink to the graphic element 4, the latter, as is known, being made of a material which can be impregnated.

In this solution, the seat 6, again located in the second laminar element 3 is only designed to receive the graphic element 4 in the closed configuration, since there is no pad present.

In the article 1 in accordance with the present invention the laminar elements 2 and 3 preferably have a substantially rectangular outline 11.

As shown in FIG. 1, in the preferred embodiment illustrated, the elements 2 and 3 are hinged together at a respective smaller side, since, in that way, use of the article 1 in the open configuration is made easy.

As illustrated in FIG. 3, in the second embodiment the elements 2 and 3 are hinged together at a respective larger side.

In more detail, the length L of the larger side of the laminar elements 2, 3 is between approximately 7 cm and approximately 9 cm.

The length L of the larger side is preferably between approximately 8.4 cm and approximately 8.6 cm, in particular it is approximately 8.5 cm.

The length L1 of the smaller side of the elements 2 and 3 is between approximately 4 cm and approximately 6 cm.

The length L1 of the smaller side is preferably between approximately 5.3 cm and approximately 5.6 cm, in particular it is approximately 5.5 cm.

It should be noticed that the preferred dimensions of approximately 8.5 cm and approximately 5.5 cm correspond to the standardised dimensions of the most widespread cards, such as credit cards, magnetic badges, cash point cards and the like so that the article 1 can be placed, for example, in the pockets of wallets designed for such cards.

Also, in particular, the thickness S2, S3 of the laminar elements 2, 3 is between approximately 0.5 mm and approximately 4.5 mm so that the overall thickness of the article 1 is less than or equal to approximately 5 mm.

As illustrated in FIGS. 1, 3, 4, 5, in the presence of the pad 5 the thickness S3 of the laminar element 3 which contains it is greater than the thickness S2 of the element 2.

Vice versa, as illustrated in FIG. 6, in the presence of the ready-inked element 4 and therefore the reservoir 9, the thickness S2 of the element 2 is greater than the thickness S3 of the element 3.

The article 1 disclosed comprises means 20 for locking the elements 2 and 3 in the closed configuration.

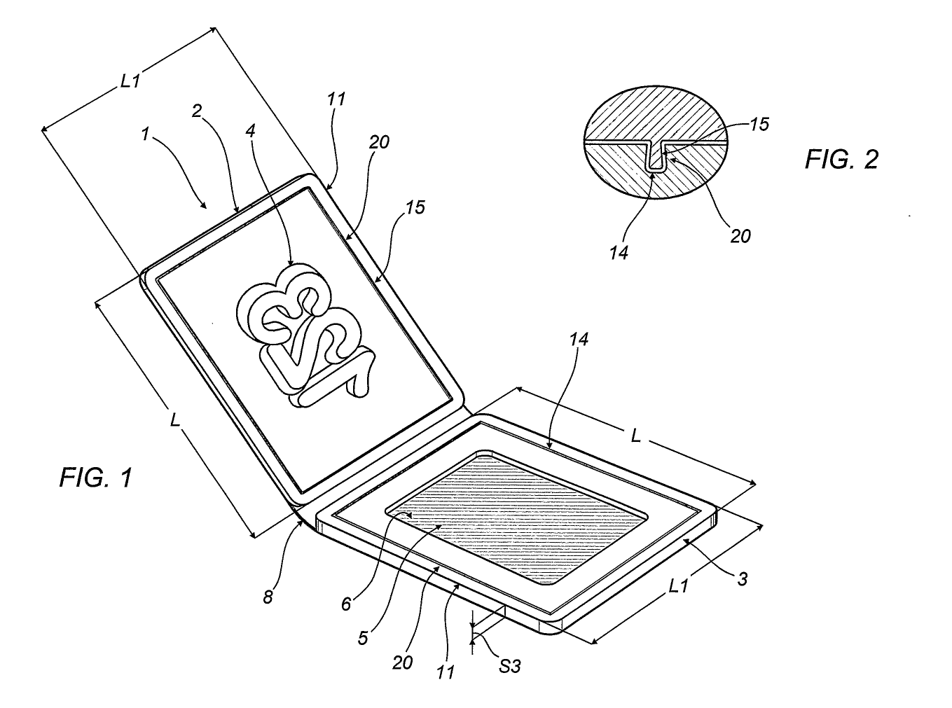

In the solution shown in FIGS. 1 and 2, the locking means 20 comprise a groove 14 made in the element 3 and a shaped profile 15 connected to the element 2. Advantageously, the groove 14 and the profile 15 may be positioned on either of the laminar elements 2, 3, the positioning depending on the preferred embodiment and the thicknesses involved. The groove 14 is preferably made in the thickest laminar element 2, 3.

The profile 15 can engage in the groove 14 in a sealed fashion, that is to say, the profile 15 has, for example, a dovetail shape and the groove 14 matches the profiles 15 so that, in the substantially known way, the profile 15, going out of shape, can enter and exit the groove 14.

The groove 14 and the profile 15 are preferably positioned at the sides of the elements 2 and 3 and form a seal, preferably hermetic, between the elements 2 and 3 in the closed configuration.

In an alternative embodiment, the groove 14 and the profile 15 are located on the sides of the elements 2 and 3 not in contact with the joining hinge.

As illustrated in FIGS. 3 and 5, the locking means 20 comprise a case 12 in which the elements 2 and 3 are placed in the closed configuration.

Therefore, the locking means 20 hold the elements 2 and 3 in contact, in particular the graphic element 4 in contact with the pad 5, and help to keep the overall dimensions of the article 1 small.

Advantageously, the means 20 also prevent the ink in the pad 5 or in the reservoir 9 from accidentally spilling out of them and marking surrounding objects, not illustrated.

As illustrated in FIG. 6, the locking means 20 comprise a clip button 13a, 13b for holding the laminar elements 2, 3 closed.

Said button has a first part 13a attached to the laminar element 2 and a second part 13b attached to the laminar element 3, the first and second parts 13a, 13b being designed to be coupled in the closed configuration.

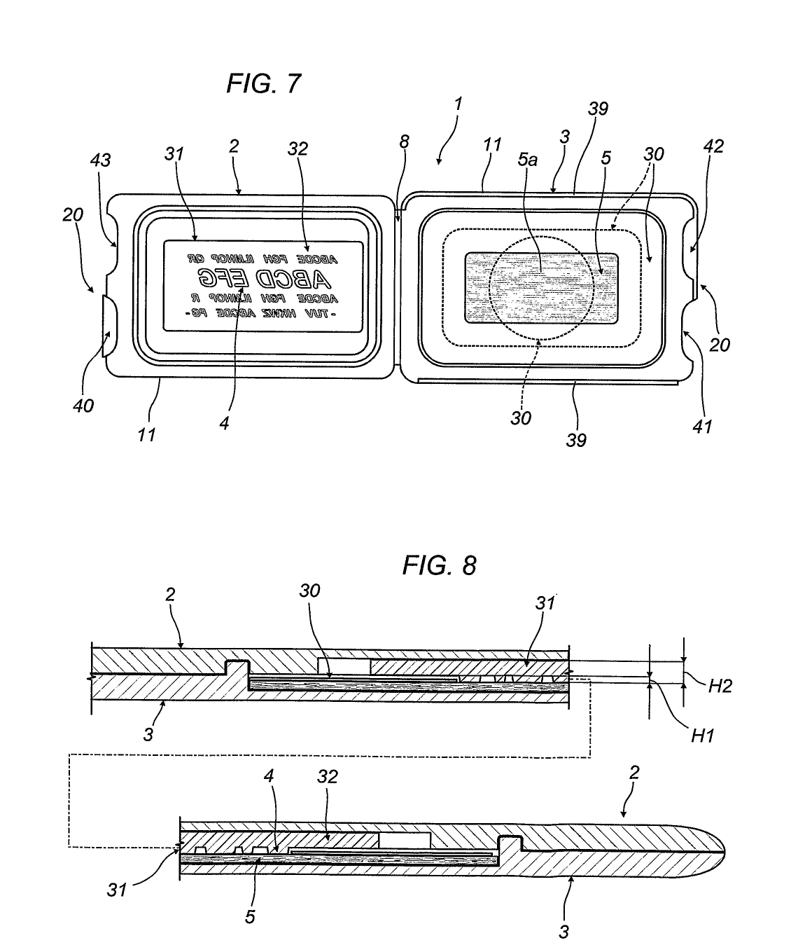

In particular with reference to FIGS. 7 and 8, in the preferred embodiment illustrated the pad 5 which can be loaded with ink is glued directly to the laminar element 3.

The article 1 for stamping comprises a mask 30 connected to the pad 5 which can be loaded with ink.

In particular the mask 30 delimits, on the pad 5, an inking zone 5a, on which the raised graphic element 4 rests when the article 1 is in the closed configuration.

It is important to notice that the graphic element 4 is part of a single stamping element 31 having a peripheral base zone 32 supporting the graphic element 4, that is to say, the peripheral base zone 32 and the raised graphic element 4 are made in a single body, for example of rubber, to form the stamping element 31.

The stamping element 31 preferably has an overall height H2 of approximately 1.2 mm.

In particular with reference to FIG. 8 it should be noticed that the mask 30 is sized in such a way that the peripheral zone 32 is opposite the mask 30 when the stamping elements 1 is closed.

The peripheral zone 32 preferably rests on the mask 30, for example when the article 1 is greatly flattened so that it can be placed in a pocket or a wallet.

In this way, the peripheral zone 32 does not make contact with the pad 5, in particular with the ink with which the pad 5 is soaked.

Dashed lines are used to show some examples of different mask 30 shapes according to the shape of the corresponding graphic element 4, not illustrated, used.

It should be noticed how the height H1 of the graphic element 4 is very small since the peripheral zone 32 may rest on the mask 30 without making contact with the pad 5.

It should also be noticed that application of the mask 30 allows the use of standardised pads, normally substantially rectangular, with a plurality of stamping elements 31 which have many different shapes.

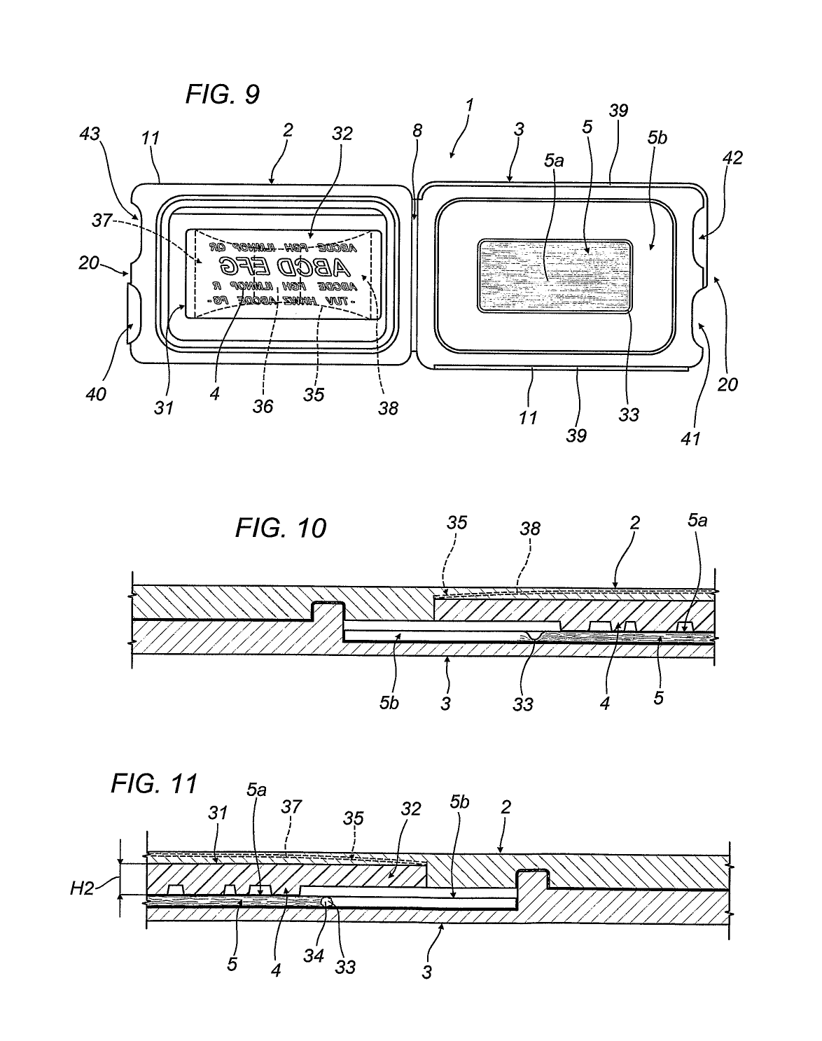

In particular with reference to FIGS. 9, 10 and 11, the preferred embodiment illustrated shows an article 1 for stamping in which the pad 5 is glued to the laminar element 3.

As illustrated in particular in FIG. 10, the pad 5 has a compact portion 33, that is to say, more compact than the rest of the pad 5, delimiting the inking zone 5a.

Said portion 33 prevents the ink normally used to load the pad 5 from spreading over the entire pad 5, that is to say, it remains mostly confined in the inking zone 5a.

The pad 5 has a portion 5b containing little ink, outside the portion 33, and on which the peripheral zone 32 of the stamping element 31 rests.

In this way, the peripheral zone 32 remains clean and, in addition, ink consumption is reduced, since the ink has a smaller evaporation surface than the entire surface of the pad 5 available to it.

The more compact portion 33 is preferably formed by pressing the pad 5.

In particular with reference to FIG. 11, it should be noticed that the more compact portion 33 is formed by a filler material 34, for example an adhesive, particularly suitable if the pad 5 is elastic, inserted in the pad 5 to delimit the inking zone 5a.

The filler material 34 is preferably injected into the pad 5 in a substantially known way.

As illustrated in FIGS. 9, 10, 11 and 14, the article 1 for stamping comprises a presser element 35, illustrated with a dashed line, for facilitating use of the article 1, that is to say, for stamping the graphic element 4 on the generic support 100.

The element 35 is preferably integrated in the laminar element 2 and acts on the stamping element 31.

The element 35 has a central portion 36 and a pair of side portions 37, 38.

The side portions 37, 38 are designed to discharge onto the stamping element 31 a force F applied on the central portion 36 so as to optimise stamping quality.

The side portions 37, 38 are preferably curved for improved distribution of the pressure on the stamping element 31.

It should be noticed that in the preferred embodiments illustrated in FIGS. 7, 9, 11 and 13 the means 20 for locking the laminar elements in the closed configuration comprise a bead 39 made on the edge of the laminar element 3.

The bead 39 is designed to clasp the perimeter of the laminar element 2 when the article 1 for stamping is in the closed configuration.

To make opening the article 1 easy, the means 20 comprise a first fastener element 40 attached to the laminar element 2 and designed for connection with the second laminar element 3 at a recess 41 made in the laminar element 3.

Advantageously, the means 20 comprise a second fastener element 42 attached to the laminar element 3 and designed for connection to the first laminar element 2 at a recess 43 made in the laminar element 2.

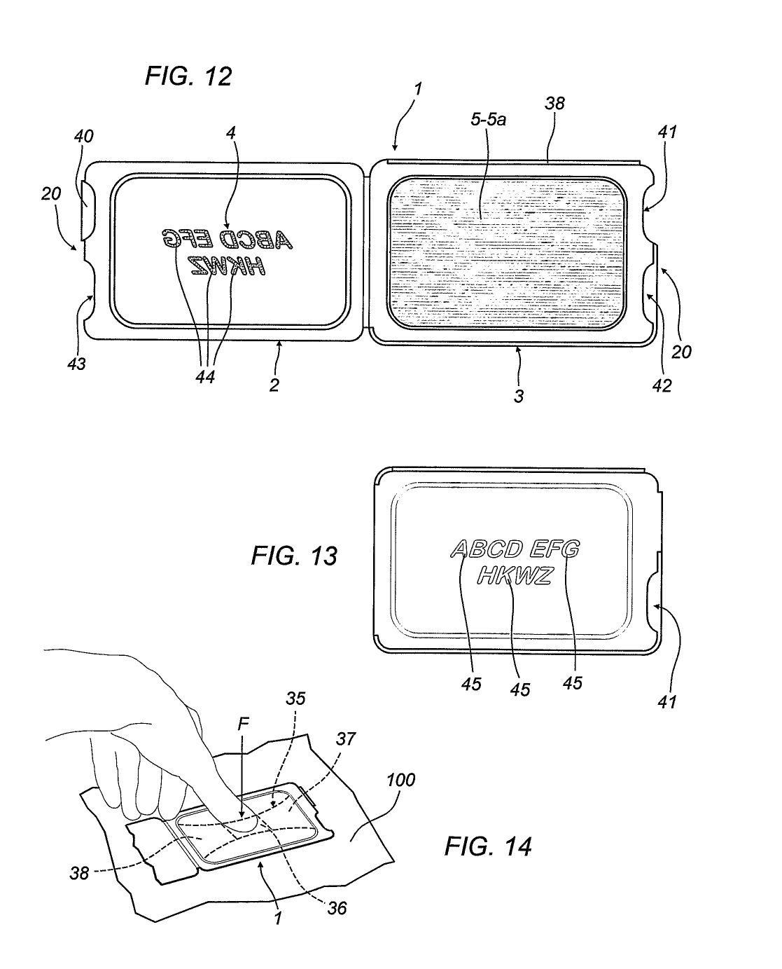

As illustrated in FIGS. 12 and 13, in the preferred embodiment illustrated the raised element 4 is stamped directly in the laminar element 2 so that the overall thickness of the article 1 for stamping is very small and the production costs reduced.

There is preferably a layer of material 44 suitable for stamping on the raised element 4.

It should be noticed that on the outer surface of the laminar element 2 there is a hollow 45 matching the raised graphic element 4 present on the inner surface of the same laminar element 2.

The invention brings important advantages.

Production of the article for stamping using laminar elements allows its thickness to be limited.

Moreover, said elements have a large surface, relative to their area, for application of the graphic element which, consequently, is larger than in known pocket stamps.

Thanks to the laminar elements, the article for stamping has a regular, smooth outer surface, recommended for stamping advertisements, drawings and any other distinctive sign.

The overall dimensions are very limited and therefore the article obtained in this way is perfectly pocket-sized.

The construction is so simple that production costs for such an object are very low.

The invention described has evident industrial applications and may be modified and adapted without thereby departing from the scope of the inventive concept. Moreover, all details of the invention may be substituted by technically equivalent elements.

1. An article for stamping characterised in that it comprises a first and a second laminar element hinged together in such a way that they can pass from a closed configuration in which they are positioned on top of one another to an open configuration and vice versa, a raised graphic element connected to the first laminar element, the graphic element being folded over the second laminar element in the closed configuration.

2. The article for stamping according to claim 1, characterised in that it comprises a pad which can be loaded with ink connected to the second laminar element, the graphic element being in contact with the pad in the closed configuration.

3. The article for stamping according to claim 2, characterised in that it comprises a mask applied on the pad which can be loaded with ink to delimit an inking zone, the graphic element preferably resting on the inking zone, the first and second laminar elements being in the closed configuration.

4. The article for stamping according to claim 3, characterised in that the mask is glued to the pad which can be loaded with ink.

5. The article for stamping according to claim 4, characterised in that the mask is of the adhesive type.

6. The article for stamping according to claim 2, characterised in that the pad which can be loaded with ink has a compact portion delimiting an inking zone the portion in particular limiting the spread of ink outside said inking zone.

7. The article for stamping according to claim 6, characterised in that the compact portion is formed by pressing the pad which can be loaded with ink.

8. The article for stamping according to claim 6, characterised in that the compact portion is formed by hot pressing the pad which can be loaded with ink.

9. The article for stamping according to claim 6, characterised in that the compact portion is formed by a filler material inserted in the pad which can be loaded with ink.

10. The article for stamping according to claim 9, characterised in that the filler material comprises an adhesive.

11. The article for stamping according to any of the claims from 1, characterised in that it comprises a presser element for substantially even distribution of a force applied on the raised graphic element.

12. The article for stamping according to claim 1 characterised in that the raised graphic element is stamped directly in the first laminar element.

13. The article for stamping according to claim 12, characterised in that it comprises a layer of material suitable for stamping placed on the raised graphic element.

14. The article for stamping according to claim 1 characterised in that the second laminar element has a seat for the pad.

15. The article for stamping according to claim 14, characterised in that the seat is designed to receive the graphic element in the closed configuration.

16. The article for stamping according to claim 14, characterised in that the second laminar element has an edge extending over the pad to hold the pad in the seat.

17. The article for stamping according to claim 1, characterised in that the second laminar element consists of an outer portion and an inner portion which are joined to one another.

18. The article for stamping according to claim 17, characterised in that the inner portion has an opening forming the seat.

19. The article for stamping according to claim 1, characterised in that it comprises an ink reservoir, located in the first laminar element, for supplying the graphic element, the graphic element being made, in particular, of a material which can be impregnated.

20. The article for stamping according to claim 19, characterised in that it comprises a seat for the graphic element in the second laminar element, the graphic element being located in the seat in the closed configuration.

21. The article for stamping according to claim 1, characterised in that the thickness of the first and second laminar elements is between approximately 0.5 mm and approximately 4.5 mm, the overall thickness of the article being less than or equal to 5 mm.

22. The article for stamping according to any of the foregoing claims, claim 1, characterised in that the first and second laminar elements have a polygonal outline.

23. The article for stamping according to claim 22, characterised in that the outline consists of a rectangle.

24. The article for stamping according to claim 23, characterised in that the length of the larger side of the first and second laminar elements is between approximately 7 cm and approximately 9 cm.

25. The article for stamping according to claim 24, characterised in that the length of the larger side of the first and second laminar elements is between approximately 8.4 cm and approximately 8.6 cm, in particular the length is approximately 8.5 cm.

26. The article for stamping according to claim 23, characterised in that the length of the smaller side of the first and second laminar elements is between approximately 4 cm and approximately 6 cm.

27. The article for stamping according to claim 26, characterised in that the length of the smaller side of the first and second laminar elements is between approximately 5.3 cm and approximately 5.6 cm, in particular the length is approximately 5.5 cm.

28. The article for stamping according to claim 23, characterised in that the first and second laminar elements are hinged together at a respective smaller side.

29. The article for stamping according to claim 23, characterised in that the first and second laminar elements are hinged together at a respective larger side.

30. The article for stamping according to claim 1, characterised in that it comprises means for locking the first and second laminar elements in the closed configuration.

31. The article for stamping according to claim 30, characterised in that the locking means comprise a profile connected to the first laminar element and a groove made in the second laminar element, the shaped profile being able to engage in the groove.

32. The article for stamping according to claim 31, characterised in that the profile and the groove are respectively located at the sides of the first laminar element and the second laminar element.

33. The article for stamping according to claim 30, characterised in that the locking means comprise a bead made on the edge of one of the first and second laminar elements the bead being shaped to clasp the perimeter of the other laminar element.

34. The article for stamping according to claim 30, characterised in that the locking means comprise a case for the article.

35. The article for stamping according to claim 30, characterised in that the locking means are designed to prevent the passage of ink beyond the first and second laminar elements.

36. The article for stamping according to claim 30, characterised in that the locking means comprise a clip button with a first part attached to the first laminar element and a second part attached to the second laminar element, the first and second parts being designed to be coupled in the closed configuration.

37. The article for stamping according to claim 1, characterised in that the first and second laminar elements are hinged together by a portion of material with reduced thickness, said first laminar element, said second laminar element and said portion with reduced thickness being, in particular, made in a single body.

38. The article for stamping according to claim 1, characterised in that the first and second laminar elements are hinged together by means of at least one adhesive strip.

39. The article for stamping according to claim 1, characterised in that the raised graphic element comprises one of alphanumeric symbols and a drawing.

40. (canceled)
